(19) United States
(12) Patent Application Publication
(10) Pub. No.: US 2025/0357680 A1
(43) Pub. Date: Nov. 20, 2025

(54) OMNI-DIRECTIONAL ANTENNA WITH HORIZONTAL POLARIZATION

(71) Applicant: ETS-Lindgren Inc., Cedar Park, TX (US)

(72) Inventors: Garret MCKERRICHER, Austin, TX (US); Zhong CHEN, Cedar Park, TX (US); Yibo WANG, Liberty Hill, TX (US)

(21) Appl. No.: 19/175,306

(22) Filed: Apr. 10, 2025

Related U.S. Application Data
(60) Provisional application No. 63/649,063, filed on May 17, 2024.

(51) Int. Cl. H01Q 21/24; H01Q 15/14; H01Q 21/00

(52) U.S. Cl. CPC H01Q 21/24; H01Q 15/14; H01Q 21/0006

(57) ABSTRACT

Omni-directional, horizontally polarized antennas are provided. According to one aspect, an omni-directional, horizontally polarized antenna includes a first reflector and a second reflector separated from the first reflector. Disposed between the first and second reflectors are a planar array of radially directed horizontally polarized antenna elements and a planar feed network configured to feed the antenna elements of the planar array. A coaxial feed structure configured to communicate electrical signals to or from the feed network is provided.

### CROSS REFERENCE TO RELATED APPLICATIONS

This application claims priority of U.S. Provisional Application Ser. No. 63/649,063 filed on May 17, 2024, which is incorporated herein in its entirety by reference.

### FIELD

The present disclosure relates to wireless communications, and in particular, to antennas, and in particular to omni-directional, horizontally polarized antennas.

### Introduction

Omni-directional antennas are used in test and measurement, consumer electronics, military, and aerospace communications etc. In test and measurement applications, precision dipoles and biconical antennas exhibit excellent pattern uniformity and have vertical polarization. These are often used as reference standards for anechoic chamber and antenna range validations.

For horizontal polarization, magnetic dipoles or magnetic loop antennas are similarly used as reference standards for antenna gain and efficiency, and chamber reflectivity validation. One such test is the Cellular Telecommunication and Internet Association's ripple test and another is site validation within ISO17025.

There is currently a push towards higher frequencies such as 18-40 GHz and beyond. These frequencies also require calibration antennas for chamber validation and the methods of calibration are currently being developed. While there are vertically polarized omni-directional antennas that cover this range there are no horizontally polarized omni-directional antennas that cover this range.

Unfortunately, magnetic loop antennas have a narrow bandwidth on the order of 5%. Therefore, several antennas are required to cover a typical frequency range. For example, 18-40 GHz would require >10 different antennas.

There are published reports of circular arrays utilizing wide bandwidth elements (such as Vivaldi elements) with horizontal polarization. However, these circular arrays and elements show substantial sidelobes that hinder performance.

### SUMMARY

Some embodiments advantageously provide antennas, and in particular omni-directional, horizontally polarized antennas.

Some embodiments include a horizontally polarized omni-directional antenna. The antenna may have a radiation pattern that resembles the radiation pattern of a magnetic dipole, but may maintain a stable radiation pattern and impedance match over a broad frequency band, greater than 75% compared to 5% for a typical magnetic dipole.

In some embodiments, an omni-directional horizontally polarized antenna includes at least one of the following features:
An array of radiating elements arranged in a circle;
A pair of reflectors on either side of the radiating elements;
A radio frequency transmission line, such as a coaxial cable which connects to a feed network that cascades to each horizontally polarized element; and/or
Optionally, a dielectric lens placed between the plates of the waveguide, arranged around the periphery to modify the radiation pattern.

In some embodiments, horizontal elements of the antenna are Vivaldi antennas. However, another wideband element could be used such as slot antennas of different shapes (circular, elliptical), log periodic elements, etc.

Traditional magnetic loop antennas are commonly used for anechoic chamber validation among other applications. Some embodiments eliminate a need for switching between different loop antennas. Some embodiments, may cover a broad frequency range and maintain a near ideal omni-directional pattern.

Some embodiments include a circular broad band element array that achieves a greater bandwidth than traditional magnetic loop antennas.

In some embodiments, a reflector design sandwiches the antenna elements of the array between two parallel waveguide plates to mitigate unwanted lobes and provide a near ideal horizontally polarized omnidirectional pattern.

The use of an array of elements with close spacing produces an antenna pattern with very low ripple. This is useful for precision antenna and chamber validation measurements.

In some embodiments, parallel waveguide plates reduce unwanted sidelobes and may be used to shape the omni-directional pattern. These plates also improve robustness of the antenna and case of fabrication.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a side view of a first example embodiment of an omni-directional, horizontally polarized antenna constructed according to principles disclosed herein;

FIG. 2A is a bottom view of one example of a printed circuit board (PCB) showing a planar array of antenna elements disposed on the PCB;

FIG. 2B is a top view of the printed circuit board of FIG. 2A showing a feed network disposed on the PCB;

FIG. 3 is a side view of a second example embodiment of an omni-directional, horizontally polarized antenna constructed according to principles disclosed herein;

FIG. 4 is a side view of a third example embodiment of an omni-directional, horizontally polarized antenna constructed according to principles disclosed herein;

FIG. 5 is a side view of a fourth example embodiment of an omni-directional, horizontally polarized constructed antenna according to principles disclosed herein;

FIG. 6 is a side view of a fifth example embodiment of an omni-directional, horizontally polarized antenna constructed according to principles disclosed herein;

FIG. 7 is a plot of voltage standing wave ratio versus frequency;

FIG. 8 is a plot of radiation patterns of an embodiment of an omni-directional, horizontally polarized antenna constructed according to principles disclosed herein;

FIG. 9 is a perspective view of one example of an omni-directional, horizontally polarized antenna 10 constructed in accordance with principles disclosed herein.

### DETAILED DESCRIPTION

Before describing in detail example embodiments, it is noted that the embodiments reside primarily in combinations of apparatus components and processing steps related to cell reparenting and slice reconfiguration. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Note further, that functions described herein as being performed by a user equipment or a network node may be distributed over a plurality of user equipmentand/or network nodes. In other words, it is contemplated that the functions of the network node and user equipment described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments are directed to antennas, and in particular to omni-directional, horizontally polarized antennas.

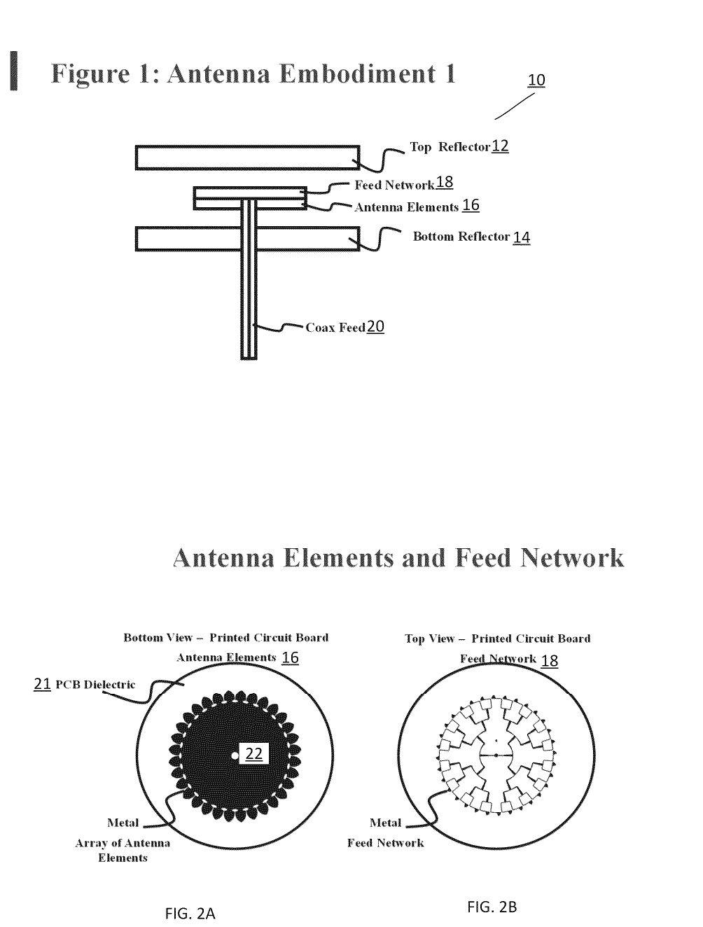

Referring to the drawing figures, in which like elements are referred to by like reference numerals, there is shown in FIG. 1 an antenna 10 constructed according to principles disclosed herein. The antenna 10 includes a top reflector 12 and a bottom reflector 14. Between the top reflector 12 and the bottom reflector 14 is an array of radially directed antenna elements 16 that may be arranged in a circle so that 360 degree coverage is provided. In some embodiments, the antenna elements 16 are spaced close together to avoid ripple in an omni-directional antenna pattern of the antenna 10. When the antenna elements 16 are arranged in a circle, the diameter of the circle may be decreased or more elements may be added. This may give flexibility in fabricating a circular array of large diameter or small diameter. A feed network 18 is provided between the top reflector 12 and the bottom reflector 14. The feed network 18 is configured to distribute signals from the coaxial feed structure 20 to the antenna elements 16.

FIG. 2A is a bottom view of an embodiment of the antenna 10 showing 32 Vivaldi antenna elements 16. FIG. 2B is a top view of an embodiment of the antenna showing the feed network 18. Although Vivaldi elements are shown, other wideband antenna elements may be employed.

In some embodiments, the top reflector 12 and the bottom reflector 14 may be configured to form a parallel plate waveguide. The cutoff frequency of the parallel plate waveguide depends on the distance a separating the top reflector 12 and the bottom reflector 14, as well as the permittivity ε and permeability u of the medium between them. The cutoff frequency may be computed according to the common parallel plate waveguide equation

$${f}_{c} = \frac{n}{2 * a * \sqrt{ϵ * μ}} .$$

As an example, a separation distance of 10 mm provides a lowest order mode cutoff frequency of about 15 GHz in air.

The feedback network 18 may include a plurality of branches that cascade to each horizontally polarized antenna element 16. An opening 22 may be seen in FIG. 2A, where a center conductor of the coaxial feed structure 20 feeds the feed network 18. The planar array of antenna elements 16 may be disposed on a PCB dielectric 21

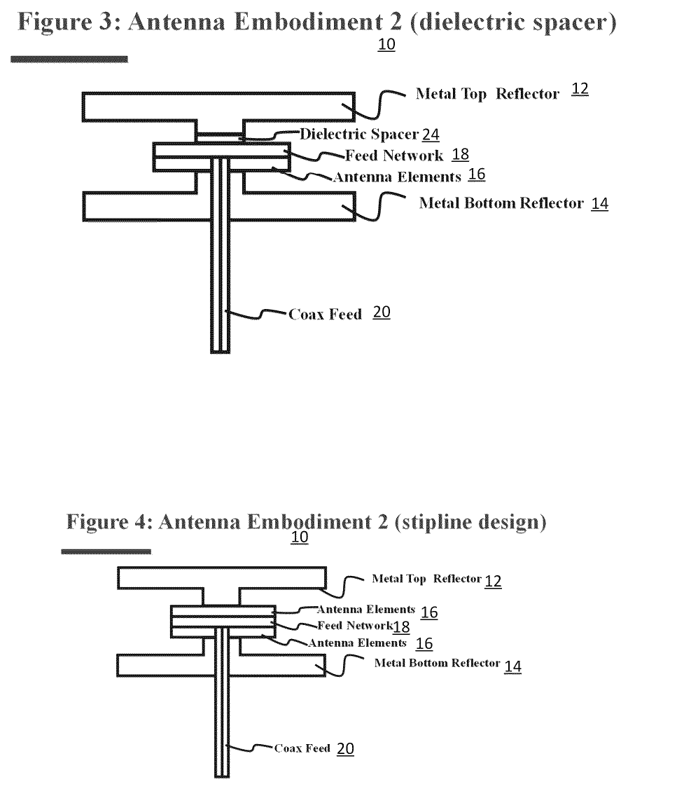

FIG. 3 depicts an example embodiment of the antenna 10 where the bottom metal reflector 16 contacts the printed circuit board dielectric 21 upon which the antenna elements 16 are disposed. At the top of the PCB 21 there may be disposed a thin dielectric spacer 24 to between the feed network 18 and the top reflector 12. A benefit of this design is further reduction of sidelobe levels.

FIG. 4 depicts a strip-line design where the antenna elements 16 are disposed on a top and bottom of the PCB 21. This is a more symmetrical design in the vertical direction. It also allows contact of both the top and bottom reflectors 12, 14 with the antenna elements 16. This contact further reduces the side-lobe levels.

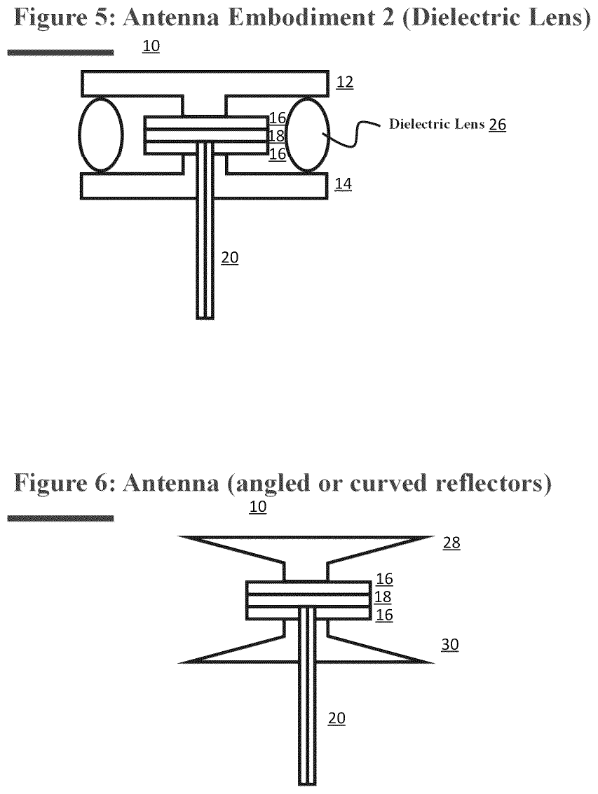

FIG. 5 is an example embodiment that incorporates a dielectric lens 26. FIG. 5 shows a convex lens, but a lens having a concave surface or flat surface but using materials with a gradient of dielectric constants (such as a Luneburg lens) may be employed to shape the beam pattern of the antenna 10 as desired.

FIG. 6 is an example embodiment with an angled top reflector 28 and an angled bottom reflector 30. The reflectors could also be curved to shape the radiation pattern as desired.

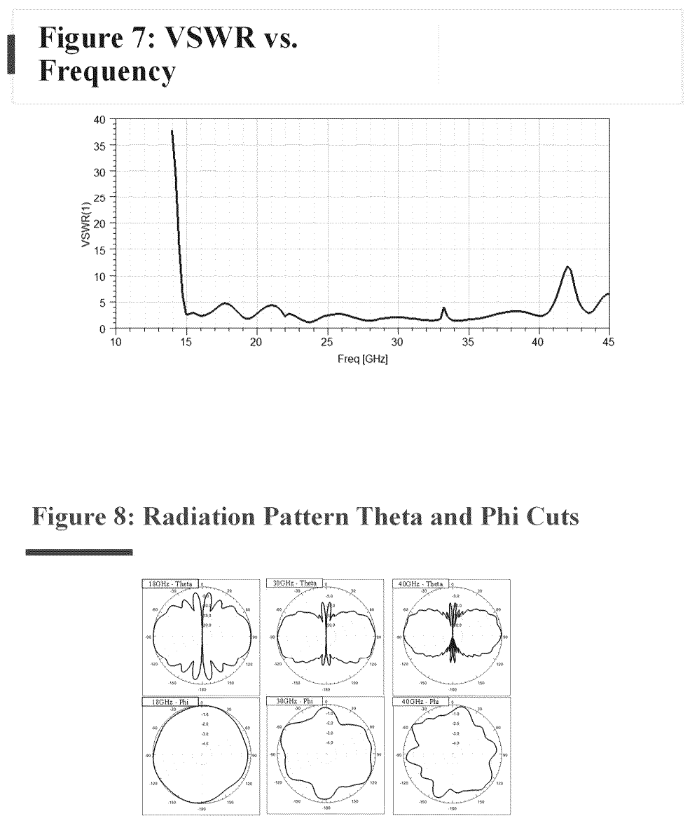

FIG. 7 shows the voltage standing wave ratio (VSWR) of an example antenna 10 utilizing the architectures of FIGS. 2A, 2B and 3. The impedance bandwidth is >75% from 18-40 GHz in this example.

FIG. 8 are radiation patterns for an example antenna 10 utilizing the architecture of FIGS. 2A, 2B and 3. The radiation pattern at 18, 30 and 40 GHz for both Theta and Phi cuts are shown. The main beam dominates at theta equal to 90 degrees due to the top and bottom reflectors 12, 14, 28, 30. The phi cut shows ripple of about 2 dB. This may be improved by optimization of the design and fabrication. The pattern is horizontally polarized like a magnetic loop antenna.

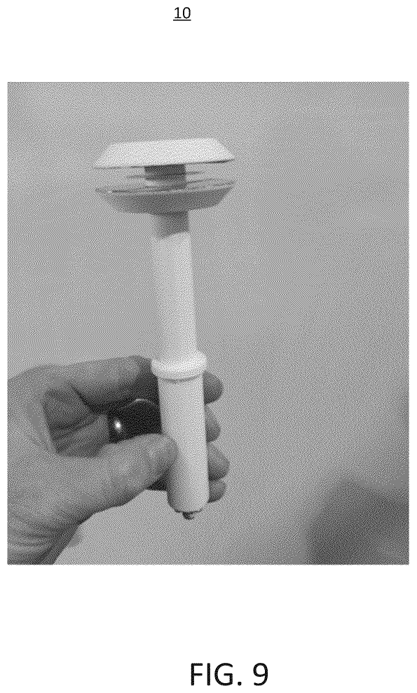

FIG. 9 is a perspective view of one example of an omni-directional, horizontally polarized antenna 10 constructed in accordance with principles disclosed herein.

In some embodiments, an omni-directional horizontally polarized antenna is provided. The antenna includes a first reflector 12, 28 and a second reflector 14, 30 separated from the first reflector 12, 28. Disposed between the first and second reflectors 12, 14, 28, 30 are: a first planar array of radially directed horizontally polarized antenna elements 16; and a planar feed network 18 configured to feed the antenna elements 16 of the planar array. A coaxial feed structure 20 is configured to communicate electrical signals to or from the feed network 18.

In some embodiments, the first planar array and the planar feed structure are on parallel sides of at least one printed circuit board (PCB) dielectric 21. In some embodiments, the PCB dielectric 21 is supported by one of the first and second reflectors 12, 14, 28, 30. In some embodiments, a center conductor of the coaxial feed structure 20 passes through an opening 22 in one of the first and second reflectors 12, 14, 28, 30. In some embodiments, the antenna includes a second planar array of antenna elements 16 parallel to the first planar array of antenna elements 16. In some embodiments, the feed network 18 is disposed between the first and second planar arrays of antenna elements 16. In some embodiments, the antenna 10 includes a dielectric spacer 24 disposed between the feed network 18 and one of the first and second reflectors 12, 14, 28, 30. In some embodiments, at least one of the first and second reflectors 12, 14, 28, 30 exhibit curvature. In some embodiments, the antenna 10 includes at least one dielectric lens 26 disposed between the first and second reflectors 12, 14, 28, 30. In some embodiments, the radially directed antenna elements 16 form a circle.

Some embodiments may include one or more of the following:
Embodiment A1. An omni-directional horizontally polarized antenna comprising:
a first reflector and a second reflector separated from the first reflector;
disposed between the first and second reflectors:
   a first planar array of radially directed horizontally polarized antenna elements; and
   a planar feed network configured to feed the antenna elements of the planar array; and
a coaxial feed structure configured to communicate electrical signals to or from the feed network.
Embodiment A2. The antenna of Embodiment A1, wherein the first planar array and the planar feed structure are on parallel sides of at least one printed circuit board (PCB).
Embodiment A3. The antenna of Embodiment A2, wherein the PCB is supported by one of the first and second reflectors.
Embodiment A4. The antenna of Embodiment A1, wherein a center conductor of the coaxial feed structure passes through an opening in one of the first and second reflectors.
Embodiment A5. The antenna of Embodiment A1, further comprising a second planar array of antenna elements parallel to the first planar array of antenna elements.
Embodiment A6. The antenna of Embodiment A5, wherein the feed network is disposed between the first and second planar arrays of antenna elements.
Embodiments A7. The antenna of Embodiment A1, further comprising a dielectric spacer disposed between the feed network and one of the first and second reflectors.
Embodiment A8. The antenna of Embodiment A1, wherein at least one of the first and second reflectors exhibit curvature.
Embodiment A9. The antenna of Embodiment A1, further comprising at least one dielectric lens disposed between the first and second reflectors.
Embodiment A10. The antenna of Embodiment A1, wherein the radially directed antenna elements form a circle.

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

What is claimed is:

1. An omni-directional horizontally polarized antenna comprising:
a first reflector and a second reflector separated from the first reflector;
disposed between the first and second reflectors:
a first planar array of radially directed horizontally polarized antenna elements; and
a planar feed network configured to feed the antenna elements of the planar array; and
a coaxial feed structure configured to communicate electrical signals to or from the feed network.

2. The antenna of claim 1, wherein the first planar array and the planar feed network are on parallel sides of at least one printed circuit board (PCB).

3. The antenna of claim 2, wherein the PCB is supported by one of the first and second reflectors.

4. The antenna of claim 1, wherein a center conductor of the coaxial feed structure passes through an opening in one of the first and second reflectors.

5. The antenna of claim 1, further comprising a second planar array of antenna elements parallel to the first planar array of antenna elements.

6. The antenna of claim 5, wherein the planar feed network is disposed between the first and second planar arrays of antenna elements.

7. The antenna of claim 1, further comprising a dielectric spacer disposed between the feed network and one of the first and second reflectors.

8. The antenna of claim 1, wherein at least one of the first and second reflectors exhibit curvature.

9. The antenna of claim 1, further comprising at least one dielectric lens disposed between the first and second reflectors.

10. The antenna of claim 1, wherein the radially directed antenna elements form a circle.

11. An omni-directional horizontally polarized antenna comprising:
a first reflector and a second reflector separated from the first reflector;
disposed between the first and second reflectors, a first printed circuit board (PCB) having disposed thereon, a first planar array of horizontally polarized first antenna elements;
a first planar feed network configured to feed the first antenna elements; and
a coaxial feed structure configured to communicate electrical signals to or from the feed network.

12. The antenna of claim 11, wherein the first planar array and the first planar feed network are on opposite sides of the first PCB.

13. The antenna of claim 12, wherein the first PCB is supported by a structure that supports at least one of the first and second reflectors.

14. The antenna of claim 11, wherein a center conductor of the coaxial feed structure passes through an opening in one of the first and second reflectors to a feed point of the first planar feed network.

15. The antenna of claim 11, further comprising a second planar array of second antenna elements disposed on the first PCB and a second planar feed network configured to feed the second planar array of second antenna elements.

16. The antenna of claim 15, wherein the second antenna elements are disposed on a second PCB.

17. The antenna of claim 16, further comprising a third PCB, the third PCB having disposed thereon the first and second planar feed networks.

18. The antenna of claim 11, further comprising a second PCB having disposed thereon the first planar feed network.

19. The antenna of claim 11, further comprising at least one dielectric lens disposed between the first and second reflectors.

20. The antenna of claim 11, wherein the first antenna elements are radially directed.
